(19) United States
(12) Patent Application Publication
(10) Pub. No.: US 2025/0010236 A1
(43) Pub. Date: Jan. 9, 2025

(54) Dry ice production system using atmospheric carbon dioxide as gas source and capable of supplying air for air conditioning

(71) Applicant: Hiroshi OKANO, Fukuoka (JP)

(72) Inventor: Hiroshi OKANO, Fukuoka (JP)

(21) Appl. No.: 18/715,563

(22) PCT Filed: Dec. 22, 2022
(86) PCT No.: PCT/JP2022/047374

§ 371 Date: May 31, 2024

(30) Foreign Application Priority Data
May 23, 2022 (JP) 2022-084014

(51) Int. Cl. B01D 53/06; B01D 53/26; C01B 32/55

(52) U.S. Cl. CPC B01D 53/06; B01D 53/261; B01D 53/265; C01B 32/55; B01D 2253/3425; B01D 2257/504; B01D 2257/80; B01D 2258/06

(57) ABSTRACT

CCU technology is being researched and developed by companies and institutions around the world, but there are many issues to be addressed, such as the cost of recovering carbon dioxide gas, how to convert it into valuable resources, conversion costs, facility costs, and whether it is commercially viable. This invention proposes a high-value-added CCU system that has potential for future development and can also be used for air conditioning supply.

The system consists of a wet type TSA carbon dioxide gas separation and concentration unit, a saturated vapor generator, a gas cooler, a gas compressor, a dehumidification unit, a gas liquefaction unit and refrigerator, a gas purification tank, and a dry ice production unit. The system is highly energy-efficient, compact, and air-conditionable, using carbon dioxide in the air as the gas source, by using the unliquefied gas from the post-purification process to purge the aforementioned separation and concentration equipment and recovering the uncoagulated gas from the dry ice production equipment.

### CROSS REFERENCE TO RELATED APPLICATIONS

This application is a U.S. National Stage Application, which claims the benefit under 35 U.S.C. § 371 of International Patent Application No. PCT/JP2022/047374 filed Dec. 22, 2022, which claims the foreign priority benefit under 35 U.S.C. § 119 of Japanese Patent Application No. 2022-084014 filed May 23, 2022 the contents of which are incorporated herein by reference.

### BACKGROUND

An energy-saving carbon dioxide gas separation, recovery, concentration, compression, cooling, dehumidification, liquefaction, and dry ice production system using carbon dioxide in the air as a gas source, which can also be supplied to air conditioning, and a wet TSA method carbon dioxide separation and concentration system.

As a countermeasure against global warming, efforts are being made on a global level to reduce carbon dioxide gas emissions from industry, automobiles, and homes as much as possible. For example, there are efforts to replace energy-intensive devices with energy-saving ones, and to replace fossil-based energy with renewable energy sources such as solar and wind power. There is also research and development of carbon dioxide capture and storage (CCS) technology, which captures unavoidable carbon dioxide gas and stores it underground or in the deep sea, CO2-EOR (enhanced oil recovery) technology, and technology to immobilize carbon dioxide by compound absorption in concrete or rock. CO2 is also immobilized by compound absorption of carbon dioxide into concrete or rock. As for technologies to efficiently recover and concentrate carbon dioxide gas, it has been considered that a power plant or a waste incineration plant, for example, would be suitable as a source of highly concentrated gas and waste heat that can be used for recovery and concentration, as shown in Patent Document 1, JP A-Heisei 6-99034. In addition, in order to improve the liquefaction efficiency of the recovered concentrated gas, Patent 2, JP-A-2010-266155 discloses an energy-saving device that uses the compression heat of a compression device as a heat source for regeneration of a carbon dioxide gas dehumidification device to regenerate the dehumidification device.

CCU (Carbon Dioxide Capture and Utilization) technology to use recovered carbon dioxide as a resource, such as reusing it as a raw material for urea, polycarbonate resin, etc., is in practical use, but it is a small fraction of the total amount of carbon dioxide emissions. In recent years, research and development of renewable fuels that convert recovered carbon dioxide gas into liquid or gaseous fuels has been conducted by various organizations in various countries.

The advantages of DAC are: (1) it can be applied to dispersed and mobile emission sources such as automobiles and airplanes, and (2) it can be used for the recovery of carbon dioxide gas emitted in the past. (2) DAC can also be applied to carbon dioxide gas emitted in the past. (3) The location of the recovery system is not restricted by the emission source, and the carbon dioxide feedstock can be obtained in the vicinity of the plant where the gas will be reused. The system is being tested on a large scale in Europe and the United States.

In order to reduce carbon dioxide emissions, it is necessary to pay attention to the amount of energy-derived carbon dioxide emissions required for recovery, concentration, and liquefaction. Therefore, the patent document 3, JP-A-2018-23976, discloses all available energy sources, from cogeneration waste heat and various renewable energy sources to geothermal and nuclear power plant waste heat.

Patent document 4, PCT-A-2017-528318 Gazette, discloses a method of using a heat pump to inject steam into a carbon dioxide adsorption structure for desorption, recovering heat from the desorbed gas and condensate in an evaporation coil installed downstream of the adsorption structure, and using the condensation coil installed upstream of the adsorption structure as a heat source to generate steam for desorption. Also disclosed is a method in which high-humidity carbon dioxide gas desorbed from the adsorption structure is recompressed and heated, fed into a kettle-type reboiler, and the condensate of the desorbed gas is recovered simultaneously with the generation of vapor for desorption through heat exchange. A heat pump that recovers heat from waste hot water and generates steam is disclosed in Patent Document 6, JP-A-2007-232357, as a technology that has recently been put into practical use.

Carbon dioxide gas is in constant demand for welding, medical use, food storage, and other applications, and its raw gas is recovered and used as a byproduct in petrochemical plants and ammonia synthesis plants. In Japan, it is estimated that 1.1 million tons of product carbon dioxide gas will be sold in the year 2021, with welding accounting for 33% of the top uses, and dry ice 32% in second place.

Liquefied carbon dioxide gas products have quality standards depending on the application, and the purification and dehumidification processes to ensure quality are also factors that increase costs. As quality standards, JISK1106 for liquefied carbon dioxide specifies one to three types of quality, including purity and moisture content. Industrial gases such as for welding are specified in JISZ3253.

In recent years, Japan has been experiencing a shortage of carbon dioxide gas sources due to the downsizing of petrochemical plants and ammonia synthesis plants, which used to be sources of carbon dioxide gas recovery, and the relocation of these plants overseas. As a countermeasure, various places are conducting demonstration tests of using exhaust gas from steel mills, power plants, waste incineration facilities, and other facilities as a source for recovering carbon dioxide gas. However, combustion gas contains many impurities such as NOx, SOx, and dust, so pretreatment is important. There are many issues to be addressed, such as ensuring the purity of the recovered carbon dioxide gas, recovery costs, and transportation costs. In addition, there is the problem of increased carbon dioxide emissions due to transportation from carbon dioxide gas collection sites on remote islands and in remote areas.

Gas sources such as petrochemical plants, which until now have been considered safe because carbon dioxide gas is recovered and used, are expected to become increasingly scarce due to the promotion of resource recycling and a shift to fuels, production methods, and materials with less environmental impact as a result of the shift to EVs for automobiles and concerns about environmental pollution from plastic waste, etc. This is expected to lead to an ever-increasing shortage of environmentally friendly fuels, production methods, and materials. In the near future, it is desirable that product carbon dioxide gas recovery sources will also be replaced by renewable sources.

In Japan, there is an annual dry ice market of 350,000 tons, of which about 300,000 tons are used for transportation and home delivery. In recent years, vaccination against new coronavirus pandemics has been promoted worldwide, and vaccines need to be stored at ultra-low temperatures, so demand for dry ice for transporting them is increasing. Demand for dry ice as a refrigerant is also increasing due to the growing demand for home delivery of refrigerated and frozen foods. Demand for dry ice fluctuates seasonally, and every summer there is a shortage of dry ice, resulting in imports of 26,000 tons from overseas. Carbon dioxide gas collected at domestic petrochemical plants is counted as emissions at the source, but imported dry ice is counted as domestic emissions, so carbon dioxide imports are increasing emissions.

In regions with long heat periods, such as Okinawa in Japan and the Philippines, Vietnam, India, Mexico, and Brazil in the world, there is a year-round demand for dry ice as a cooling material. However, many of these regions are remote from carbon dioxide gas sources, etc., so dry ice must be transported to demand areas by dedicated gas carriers, dedicated tank trucks, carbon dioxide cylinders, or as dry ice, which increases carbon dioxide emissions. In the area of dry ice production efficiency, Patent Document 7, JP-A-2006-193377, discloses a method to increase the yield of dry ice from liquid carbon dioxide in storage tanks. In the article 8, a device for recovering and liquefying carbon dioxide gas that has not condensed (turned into dry ice) in a device for producing dry ice using liquefied carbon dioxide is disclosed.

Dry ice is a refrigerant that utilizes the latent heat of carbon dioxide and is used for food storage, transportation, and other refrigeration purposes, so it is not required to be as pure as other liquefied carbon dioxide products. The gas released into the atmosphere by the use of dry ice is not an environmental burden. In other words, we believe that establishing a marketable system for renewable carbon dioxide will be one of the measures to prevent global warming.

### SUMMARY

The problem to be solved by this invention is as follows.

CCU technology is being researched and developed by various companies and institutions around the world, but there are many issues to be addressed, such as the cost of carbon dioxide gas capture, as well as the conversion cost, equipment cost, and commercial viability, and what kind of valuable resources will be used to convert it. Among the various possible CCU technologies, it is hoped that the CCU system will be put into practical use relatively early in the market as a pioneer in this field.

Therefore, instead of installing the system in a facility that emits a large amount of carbon dioxide gas, such as a typical power plant or petrochemical plant, the system is relatively compact and can be implemented on the scale of a small factory in a place where recovered carbon dioxide gas is used, and the waste heat and exhaust gas from each device in the overall system can be mutually utilized to save energy. The aim was to create an airborne carbon dioxide gas separation, concentration, liquefaction, and dry ice production system that is highly energy-efficient and can also be air-conditioned.

As a related art document, Patent Document 1, JPA-Heisei 6-99034, discloses an example of a plant for separating and concentrating liquefied carbon dioxide from a combustion furnace. The carbon dioxide gas separation and concentration methods are the TSA, PSA, and PTSA methods. A method to increase the recovery rate and purity of liquefied carbon dioxide by refluxing the unliquefied gas after liquefaction is disclosed, but it does not mention a method to improve energy efficiency.

Recovered carbon dioxide gas is condensed and dehumidified with cooling because the partial pressure of water vapor increases with compression and condensate is easily generated. In addition, due to quality requirements, the gas is dehumidified to a low dew point temperature using an absorption type or an adsorption type dehumidifier such as a PSA or TSA type dehumidifier. Patent document 2, JP-A-2010-266155, relates to energy saving of recovered carbon dioxide gas compression, cooling, and liquefaction equipment, and discloses a method to improve energy saving by using the cold heat of the return refrigerant from the carbon dioxide liquefaction refrigeration coil for cooling and dehumidification in the pre-liquefaction process. However, it does not take into account the energy efficiency of the carbon dioxide gas separation and concentration equipment in the preceding stage or the use of waste heat generated in the compression and liquefaction equipment.

In the DAC technology of Patent document 3, JP-A-2018-23976, it is said that cogeneration waste heat, solar heat, biomass, geothermal heat, nuclear power, and process heat generated in the recovery and concentration process are used as heat sources for separating and concentrating carbon dioxide gas, but no specific method is disclosed. In any case, however, implementation is limited to locations and environments where heat source energy is available.

Patent document 4, PCT-A-2017-528318 Gazette, relates to DAC technology. It discloses a method of sorbing carbon dioxide gas in a carbon dioxide gas separation and concentration device by heating the gas with a heat exchanger element incorporated in the adsorption structure during sorption and simultaneously recovering the carbon dioxide gas through superheated steam, while cooling the gas by flowing a cooling fluid through the heat exchanger element during sorption. When switching between sorption and desorption, the heat capacity of the heat exchanger element itself hinders the thermal efficiency of the entire system and complicates it. Another example is disclosed in which a steam generation heat exchanger and a steam condensation heat exchanger are connected to a heat pump in order to recover condensation heat for steam generation. Also disclosed is a method of re-compressing the above-mentioned carbon dioxide-containing gas, raising the temperature and the partial pressure of water vapor, feeding it into a kettle-type reboiler as a heat source, generating steam for desorption through a heat exchanger, and reusing the condensate. In addition, in order to prevent thermal degradation of the amine adsorption structure and to improve the purity of the recovered gas, vacuum evacuation and pressurization operations must be repeated, which requires energy and complicates the equipment.

Patent Document 5, JP-B-6510702, describes a process of sorbing carbon dioxide gas by rotating a honeycomb rotor having a carbon dioxide gas sorption function in a sealed casing having at least a treatment sorption zone and a desorption zone, and contacting the honeycomb in the sorption zone with a mixed gas containing carbon dioxide gas in a wet state of the honeycomb and vaporizing and cooling it. In the carbon dioxide gas recovery and concentration method, which includes the process of sorbing carbon dioxide gas by introducing saturated vapor into the honeycomb sorbed with carbon dioxide gas in the sorption zone, a gas circulation circuit connecting the inlet and outlet of the sorption zone is configured, a fan and a vapor generating heater are provided in the circuit, and the gas in the circulation circuit is circulated while the above. The method is composed of a gas circulation circuit connecting the inlet and outlet of the desorption zone, a fan and a steam generator heater in the circuit, and a wet TSA method carbon dioxide gas separation and concentration system in which saturated steam is supplied by boiling evaporation pressure by heating the water supply to the heat transfer surface of the steam generator heater while circulating the gas in the circulation circuit. The oxygen concentration of the circulating gas is reduced to prevent thermal oxidation and deterioration of the amine sorbent, but on the other hand, there was insufficient desorption due to the partial pressure of the carbon dioxide gas and a decrease in the recovery rate due to this.

Patent document 6, JP-A-2007-232357, discloses a heat pump type steam and hot water generator that recovers heat from waste hot water and generates and supplies steam and hot water by a heat pump. Although engineers can easily conceive of the possibility of using this device for carbon dioxide gas separation and concentration, it is necessary to be creative in how to use the steam.

There is a patent document 7, JP-A-2006-193377, regarding a device that improves the production efficiency of dry ice. When liquefied carbon dioxide gas is released under atmospheric pressure, the latent heat of vaporization cools and sublimates the carbon dioxide gas to produce dry ice, but the resulting dry ice is only about 40% of the released carbon dioxide gas, the rest being gasified. This patent discloses that the yield can be improved to 60-70% by supercooling the liquefied carbon dioxide before releasing it. The patent 8, JP-A-2016-204234, discloses a technology to prevent gas loss in the dry ice production process by recovering carbon dioxide gas that has not condensed and recompressing it into liquefied gas.

Patent document 9, JP Patent Application No. 2021-211907, discloses DAC technology and a method of separating and concentrating carbon dioxide gas in air by wet TSA method, but it does not disclose the use of recovered carbon dioxide gas or the heat source for desorption of carbon dioxide separation and concentration equipment, and without solving these two critical issues, the CCU technology will not be promoted widely.

Liquefied carbon dioxide products are standardized, and depending on the application, they may be purified to an even higher purity than the distributed products. When carbon dioxide gas is used for medical, food, chemical raw materials, or welding applications, there are quality requirements that affect the quality of the results, and the purity, moisture content, etc. are specified in JIS. However, dry ice, which is also a carbon dioxide product, is used as a refrigerant and has no JIS standard, and the manufacturer's quality guidelines stipulate that it be white and odorless. The product carbon dioxide gas must be dehumidified to a moisture content below a standard value, but in dry ice production, moisture is added to solidify snow dry ice, so the purity is not strict, and impurities such as oxygen, nitrogen, and moisture content, which are problematic in product gas, are not a problem in dry ice.

The inventor has developed a small, compact, energy-saving, high value-added system for producing carbon dioxide gas separation and concentration dry ice by recovering carbon dioxide gas from the air using a rotor with a carbon dioxide gas sorption function and recovering the waste heat from compression, cooling and dehumidification, waste heat from the gas liquefaction refrigerator, and waste heat from air conditioners generated in the system during the compression-liquefaction process of the recovered carbon dioxide gas. The system is a small, compact, and highly energy-efficient carbon dioxide gas separation and concentration dry ice production system that utilizes the exhaust heat of the carbon dioxide gas separation and concentration equipment as a heat source for the wearing of the equipment.

Carbon dioxide gas separation, concentration, cooling, liquefaction, and dry ice production system including of a wet TSA carbon dioxide gas separation and concentration unit, a saturated vapor generator, a cooling dehumidification unit, a gas compression unit, an adsorption dehumidification unit, a cooling unit, a gas liquefaction unit, a refrigerator and cooling tower, a liquefied carbon dioxide purification tank, and a dry ice production unit In the dry ice production system, the uncondensed gas from dry ice production is collected in the gas compressor, and the wet TSA carbon dioxide gas separation and concentration system has a rotor with carbon dioxide gas sorption capacity and a highly insulated structure with a processing zone, a purge zone and a desorption zone, at least in order of direction of rotation. In the processing zone, carbon dioxide gas is sorbed while air is introduced and vaporized and cooled in the moistened state of the rotor, and in the purge zone, unliquefied gas from a liquefied carbon dioxide purification tank is introduced and air contained in the rotor void is purged and exhausted. In the purge zone, saturated vapor generated by a vapor generator is introduced at vapor generation pressure, and carbon dioxide gas is sorbed and recovered and concentrated by condensation heat of the vapor.

As a method to further improve energy saving, a rotor with carbon dioxide gas sorption capacity is installed in a highly insulated “purge and recovery block” with a processing zone, a purge zone, one or more recovery zones and a desorption zone in the order of rotation direction, each of which is stored and rotated in a sealed casing. In the purge zone, unliquefied gas from the liquefied carbon dioxide purification tank is introduced to exhaust the air contained in the rotor void, and saturated vapor is introduced into the desorption zone to desorb highly concentrated carbon dioxide gas by the condensation heat of the vapor, is desorbed and introduced into the recovery zone at the front end of the rotary direction, and further to the recovery zone at the front end of the rotary direction, the wet type TSA carbon dioxide gas separation and concentration system is proposed to collect the gas by sequentially passing through multiple recovery zones toward the front end of the rotary direction. The aforementioned wet type carbon dioxide separation and concentration equipment of the dry ice production system can be converted to this equipment to save even more energy.

The value-added improvement for the diffusion of this proposed system was considered by using the process outlet air with low carbon dioxide gas concentration as air conditioning supply air. The air that passes through the process zone of the wet TSA carbon dioxide gas separation and concentration equipment is cooled and dehumidified by the cooling coil and used as air conditioning supply air, and the cooling coil drain water is collected and used as feed water for the saturated steam generator, enabling energy saving of air conditioning, added value improvement of the proposed dry ice production system, and water saving.

In order to further improve the energy efficiency of the entire system, the recovery and utilization of exhaust heat generated in and near the system was investigated. The saturated steam generator is a heat pump steam generator using exhaust heat, and exhaust heat from the refrigeration system that compresses, thermally cools, and liquefies the recovered carbon dioxide gas and from the nearby cooling and air conditioning system is recovered and supplied to the steam generating heat pump to generate saturated steam.

Energy saving of low dew point dehumidification of recovered gas was also considered. By incorporating a dehumidification device that introduces compressed high-temperature gas from a gas compressor into the regeneration zone of a honeycomb rotor adsorption dehumidifier that has a process zone and a regeneration zone, and desorbs the adsorption water from the rotor, passes the outlet gas through a cooling coil to cool and dehumidify it, and then introduces it into the process zone for absorption and dehumidification, energy-saving low dew-point dehumidification can be achieved. The dehumidifier is then introduced into the processing zone and dehumidifies the adsorbed water.

The dry ice production system using air-conditionable carbon dioxide in air as a gas source has a wet TSA carbon dioxide gas separation and concentration unit, a saturated vapor generator, a cooling dehumidification unit, a gas compression unit, an adsorption dehumidification unit, a cooling unit, a gas liquefaction unit, a refrigerator, a liquid carbon dioxide purification tank and a dry ice The system has a production unit. Any carbon dioxide gas separation, concentration, and liquefaction plant requires compression, cooling, and liquefaction processes, each of which consumes energy and generates waste heat. The carbon dioxide gas compression and liquefaction process generates a large amount of heat from compression and latent heat from cooling and liquefaction. The heat of compression and the latent heat of cooling and liquefaction are usually dissipated into the atmosphere by heat sinks such as cooling towers. By recovering this heat and using it as energy for the separation and concentration of carbon dioxide in the air, a system that can be installed anywhere away from large carbon dioxide sources and available waste heat sources becomes possible.

When liquefied carbon dioxide is put into the purification tank, it also contains unliquefied gas. Since the unliquefied gas contains impurities derived from the air component, it is exhausted to improve purity and reduce resistance to introduction of the liquefied gas into the tank. The proposed system uses this unliquefied gas as purge gas for the wet TSA carbon dioxide gas separation and concentration system, which has the effect of improving the concentration of recovered gas. In addition, in dry ice production systems, the recovery of undeposition gas from dry ice production can be returned to the gas compression system described above to improve the recovery efficiency and energy efficiency of the entire system.

The wet TSA carbon dioxide gas separation and concentration system has a processing zone, a purge zone, and a desorption zone. In the processing zone, carbon dioxide gas is sorbed while being vaporized and cooled by contacting air containing carbon dioxide gas in the wet state of the rotor, and unliquefied gas from the liquefied gas purification tank is introduced into said purge zone to The air contained in the rotor void is purged and exhausted before rotating and moving to the sorption zone, preventing the migration of air to the sorption zone, improving the concentration of recovered carbon dioxide gas, and preventing thermal oxidation and degradation of the sorbent in the sorption zone. In the desorption zone, saturated steam of around 100° C. is introduced under boiling pressure to desorb and recover the sorbed carbon dioxide gas. 100° C. means that the boiling point of water varies with pressure, so a variation of a few degrees, plus or minus, can be expected due to the resistance of introducing saturated steam into the desorption zone and air pressure.

In order to further improve the energy-saving performance of the wet TSA carbon dioxide gas separation and concentration system, we proposed a configuration in which the rotor zones are divided and sealed in the order of rotational direction into a processing zone, a purge zone, and one or more recovery zones and a desorption zone. Unliquefied gas from the liquefied gas purification tank is introduced into the purge zone to exhaust air contained in the rotor void, and saturated vapor of around 100° C. is introduced into the desorption zone to desorb highly concentrated CO2 gas by condensation heat of the vapor. The enthalpy of the desorption outlet gas is recovered by passing it through the recovery zone on the front side of the desorption zone in the direction of rotation, which has the effect of preheating the rotor prior to desorption and reducing the cooling and dehumidification load in the subsequent process because the recovered gas is pre-cooled, further reducing the risk of air entering the desorption zone.

The recovery zone can have more than one recovery zone. The gas from the outlet of the desorption zone is introduced into the recovery zone 1 at the front stage in the rotational direction, and then into the recovery zone 2 at the front stage in the rotational direction, passing through multiple recovery zones sequentially toward the front stage in the rotational direction. The total length of the recovery zones can be assumed to be equivalent to 200 to 400 mm, although this depends on the width of the rotor and the flow velocity through it, based on the knowledge of the heat exchange efficiency of the rotary heat exchanger. For example, when the number of cells is 190 and the rotor width is 50 mm, a desirable total passage length of 200 mm can be estimated to be 4 passages, but this should be determined by testing and judging economic efficiency and effectiveness.

On the other hand, the air that passes through the process zone has a lower concentration of carbon dioxide gas, and the temperature hardly changes due to the evaporative cooling effect, but the absolute humidity becomes higher. This air is cooled and dehumidified by the cooling coil, and high air quality air with low carbon dioxide concentration is used for air conditioning supply, which is expected to improve the intellectual productivity of the occupants. Drain water from the cooling coil is recovered and fed to the saturated steam generator, further improving the benefits and economics of the installation in terms of initial and running costs.

To liquefy recovered carbon dioxide gas, it must be compressed and cooled. When compressed to 6.4 Mpa by multi-stage compression, the temperature of the gas becomes about 130° C. Steam generation is possible through heat exchange with this gas, but if the amount of steam generated is not sufficient, the exhaust heat from the cooler, liquefier, and chiller in the system, and if necessary, the air conditioner in a neighboring facility, can be recovered to generate steam. The heat source of the heat pump can be used to provide desorption energy for the carbon dioxide gas separation, recovery, and concentration system.

Low dew point dehumidification of recovered gas can be combined with a rotor adsorption dehumidifier. Compressed high-temperature gas from a gas compressor is introduced into the regeneration zone of a honeycomb rotor adsorption type dehumidifier that has a process zone and a regeneration zone to desorb adsorbed water from the rotor. The gas that passes through the zone is cooled and dehumidified by passing through the next cooling coil, as the dew point temperature (absolute humidity) increases and the temperature drops due to the heat of adsorption. In addition, the recovered gas passes through the processing zone of the rotor adsorption dehumidifier, where it is dehumidified to a low dew point temperature and introduced into the compressor in the next stage.

Since the dehumidification method can dehumidify the recovered gas to a negative dew point temperature, which is lower than the temperature of the cooling coil, the final dehumidification effect is equivalent to the conventional PSA, TSA, and PTSA methods, while the regenerative energy can use the excess heat in the system. Thus, a honeycomb rotor rotary dehumidifier, which is a form of the TSA dehumidification method, is well known, but combining it in this way with the system will contribute to improving the energy efficiency of the entire system.

As described above, the system saves energy as a whole because the waste heat generated in the system is recovered to generate saturated vapor, which is used as a source of energy to desorb sorbed carbon dioxide gas. Of course, electricity is required to run the system, but the system is well matched with photovoltaic power generation because of the high solar radiation during the time of year and in areas with high demand for dry ice. In addition, since the area is hot, cooling exhaust heat can be used, and the low-carbon dioxide gas supply air after treatment allows for high-quality air conditioning without excessive ventilation. In the case of air conditioning, energy-saving effects can also be expected due to the enthalpy recovery of the return air.

Furthermore, the system does not depend on carbon dioxide gas sources or waste heat sources as in the conventional technology, and since small- and medium-scale systems can be established, they can be dispersed to various dry ice demand areas, reducing carbon dioxide gas emissions from dry ice and carbon dioxide gas transportation and improving the overall business efficiency. In addition, the carbon dioxide gas separation and concentration system has a much lower heat capacity than the conventional absorption liquid method, and the entire system can be easily started, stopped, and deactivated according to the need for dry ice production, with little associated heat loss.

As described above, the combination of dry ice production and energy-saving air conditioning with low carbon dioxide gas concentration air can promote the spread of CCU technology and accelerate the reduction of CO2 emissions in petrochemical plants, which have been allowed to emit CO2 so far.

### BRIEF DESCRIPTION OF THE DRAWINGS

These and/or the other aspects and advantages will become apparent and more readily appreciated from the following description of the embodiments, taken in conjunction with the accompanying drawings.

FIG. 1 shows the basic flow diagram of the first embodiment, a dry ice production system using an air-conditioned carbon dioxide gas source.

FIG. 2 shows a detailed view of the carbon dioxide gas separation and concentration system of the first embodiment.

FIG. 3 shows a basic flow diagram of the second embodiment, an air-conditioned, airborne carbon dioxide gas source dry ice production system.

FIG. 4 shows a detailed view of the carbon dioxide gas separation and concentration system of the second embodiment.

FIG. 5 shows a cross-sectional illustration of the principle of the carbon dioxide gas separation and concentration system of the second embodiment, including the treatment, purge, second recovery, first recovery, and desorption zone sections.

FIG. 6 shows a cross-sectional illustration of the principle of the carbon dioxide gas separation and concentration apparatus of the third embodiment.

FIG. 7 is an illustration of the principle of the honeycomb rotor dehumidifier of the second embodiment.

FIG. 8 shows a flow diagram of a small-sized test apparatus that was actually tested on a prototype basis.

FIG. 9 shows the projected practical application of a medium-sized cassette.

FIG. 10 shows the expected practical application of a unit having four medium-sized cassettes.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

The following is a detailed description of an embodiment in which the proposed system is applied, based on the drawings. In each drawing, parts and materials with the same symbol have the same or similar configuration, and duplicate explanations of these parts and materials shall be omitted as appropriate. In addition, in each drawing, parts and materials that are unnecessary for explanation are omitted from the illustration as appropriate.

The inventor came to these proposals through research and development of a compact and energy-saving rotor-type wet TSA (thermal swing) method for separating and concentrating carbon dioxide gas in the air. First, the principle and merits of the wet TSA method are explained. The wet TSA method uses saturated steam instead of superheated steam to desorb carbon dioxide gas, and the condensation heat of the saturated steam is used to desorb and concentrate the carbon dioxide gas. Not only is high concentration recovery possible because heated air or gas is not used for desorption as in the conventional dry TSA method, but also the rotor is quickly cooled immediately after desorption because water vapor condenses simultaneously with desorption and water remains on the inner surface of the honeycomb and carbon dioxide gas is sorbed while evaporating and cooling in the treatment sorption zone, and at the same time Since the heat of sorption of carbon dioxide gas is traded off to suppress the temperature rise, the carbon dioxide gas sorption performance and energy saving are dramatically improved over the conventional dry TSA method and superheated steam TSA method.

The sorbent is desorbed with saturated vapor at around 100° C. without air, which has the effect of preventing thermal oxidative degradation of the amine sorbent. In addition, when the sorbent surface is covered with condensation water when it rotates and comes into contact with air in the processing zone immediately after sorption, direct contact with oxygen is avoided, and the sorbent is quickly cooled by the evaporative cooling effect of the passing process air, thereby suppressing thermal oxidative degradation. The proposed system has been ingeniously designed to further prevent thermal oxidative deterioration of the sorbent, improve the recovery rate and concentration, and enhance energy conservation in the aforementioned wet TSA method.

### The First Embodiment

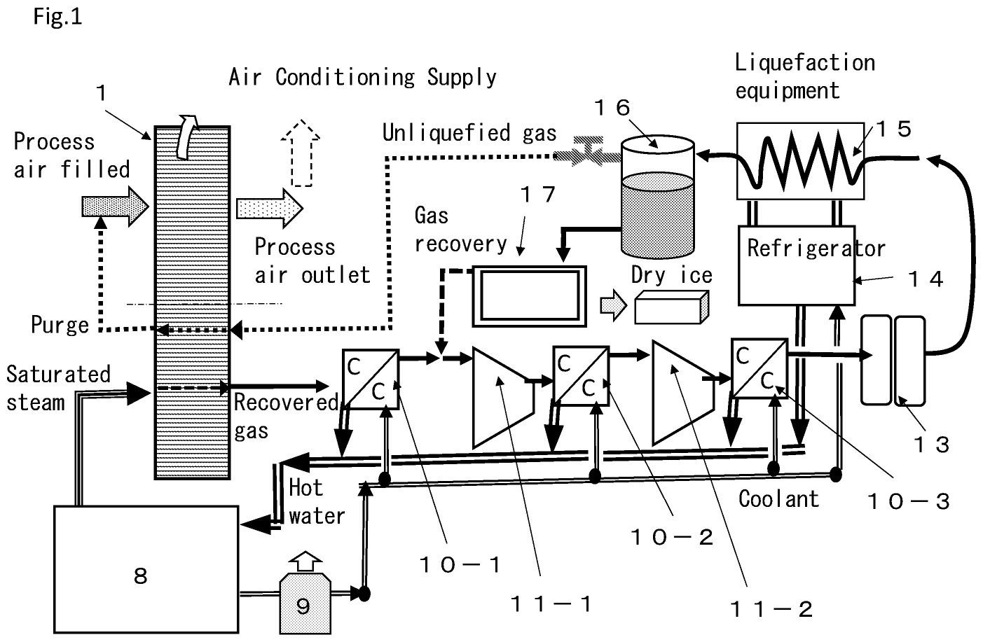

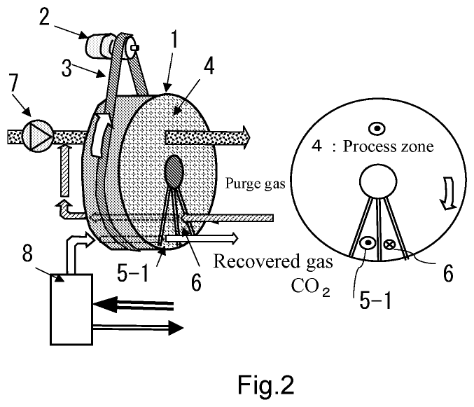

FIG. 1 shows the overall system of Form 1. Since the process gas is air or air-conditioned air, no special pretreatment is required. Water-soluble impurities and fine dust are removed and discharged as drainage together with water condensed in the cooling coil in the middle of the system. If necessary, an activated carbon deodorizing filter can be easily added to the treatment air intake. FIG. 2 shows the details of the carbon dioxide gas separation and concentration system. Rotor 1, which is capable of sorbing carbon dioxide gas, is driven and rotated by a rotor drive motor 2, which is driven by a belt 3. A chain drive can also be selected for larger systems. When process air is introduced into the processing zone 4 of the rotor by a fan 7, the rotor in its moist state is vaporized and cooled while carbon dioxide gas is sorbed, and the heat of sorption is cooled and removed at the same time.

When the rotor rotates to purge zone 6, unliquefied gas from the liquefied carbon dioxide purification tank is introduced, and the air contained in the rotor void is purged and exhausted to the processing zone side. This purging has the effect of preventing air from mixing with the recovery gas, thereby increasing the recovery concentration, and preventing oxygen from mixing with the hot desorption zone, thereby avoiding thermal oxidation degradation of the sorbent material and improving durability. In addition, the sorption of carbon dioxide gas, which has a higher concentration than that of air, immediately before sorption is expected to improve the recovery rate. The purge gas can pass in either direction to purge the air in the rotor void, but if the purge gas is exhausted toward the entrance of the process zone and merged with the treated air, even if relatively high concentrations of carbon dioxide gas are exhausted due to excess purge gas, they will be re-sorbed in the process zone and will not be wasted.

When the rotor rotates in the desorption zone 5-1, saturated steam is introduced at the steam generation pressure from the saturated steam generator, and the carbon dioxide gas is desorbed by condensation heat and condensate remains in the rotor. The mixture of desorbed carbon dioxide gas and steam is passed through the cooling coil 10-1 in FIG. 1 to be cooled and dehumidified. The cooled and dehumidified recovered gas is then introduced into the first-stage compression unit 11-1, where it is pressurized and heated. Since it is difficult to liquefy carbon dioxide gas in a single-stage compression, the heated gas is recooled in cooling coil 10-2 and introduced into second-stage compressor 11-2, where it is pressurized to about 4 Mpa. The gas may be further recooled and pressurized to about 6.4 Mpa in the third-stage compressor, which is not shown in FIG. 1. The final pressurized gas is recooled, dehumidified to a low dew point temperature by the adsorption dehumidifier 13, and then liquefied by cooling to below the liquefaction temperature in the liquefaction unit 15.

The higher the pressure of carbon dioxide gas, the easier it is to liquefy, but the greater the compression energy, the greater the dissolution of impure gases in the liquefied gas, and the lower the purity of the gas. Conversely, a lower pressure requires cooling to a lower liquefaction temperature, which increases the cooling load, and a lower coefficient of performance (COP) of the chiller, which increases the energy consumption of the chiller. The liquefied carbon dioxide is sent to a refining tank, where unliquefied gas is extracted to improve purity and stored. The extracted gas is used to purge the aforementioned separation and concentration equipment.

The amount of unliquefied gas withdrawn from the refining tank must be a sufficient surplus to purge the amount that is contained in the rotor void and migrates. If the amount is insufficient, air will be mixed into the recovered gas. Even if there is an excess amount, it will not be wasted, because the unliquefied gas that has passed through the purge zone will merge with the process air, pass through the process zone again, and be sorbed. Since the volume of purge gas fluctuates due to temperature and humidity changes and carbon dioxide gas sorption, it is practical to adjust the volume by measuring the carbon dioxide gas concentration at the purge zone 6 gas outlet.

The recovered gas is heated to 100° C. or higher by compressors 11-1 and 11-2, and the heat from this gas can be used to generate saturated vapor, but if the heat from this gas alone is insufficient to generate desorption energy, the heat from cooling and dehumidifying the recovered gas, heat from compression, and heat from liquefaction to liquefy can be used. That is, if the waste heat such as cooling and dehumidifying heat, compression heat, and latent heat of liquefaction of the recovered gas is insufficient to generate saturated steam, it is recovered in a steam-generating heat pump and introduced into the desorption zone of the carbon dioxide separation and concentration equipment described above. The above configuration enables the separation and concentration of carbon dioxide gas in air by recovering and utilizing the waste heat generated in the compression, cooling dehumidification, cooling, and liquefaction processes of separated and concentrated carbon dioxide gas, making the airborne carbon dioxide gas source dry ice production system more energy efficient and compact than conventional technology.

### Second Embodiment

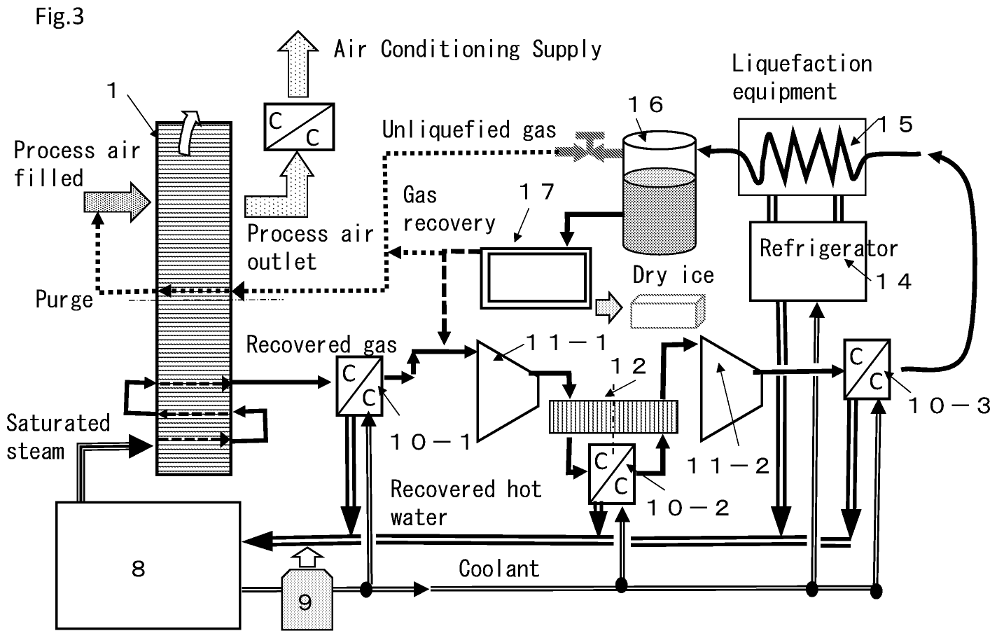

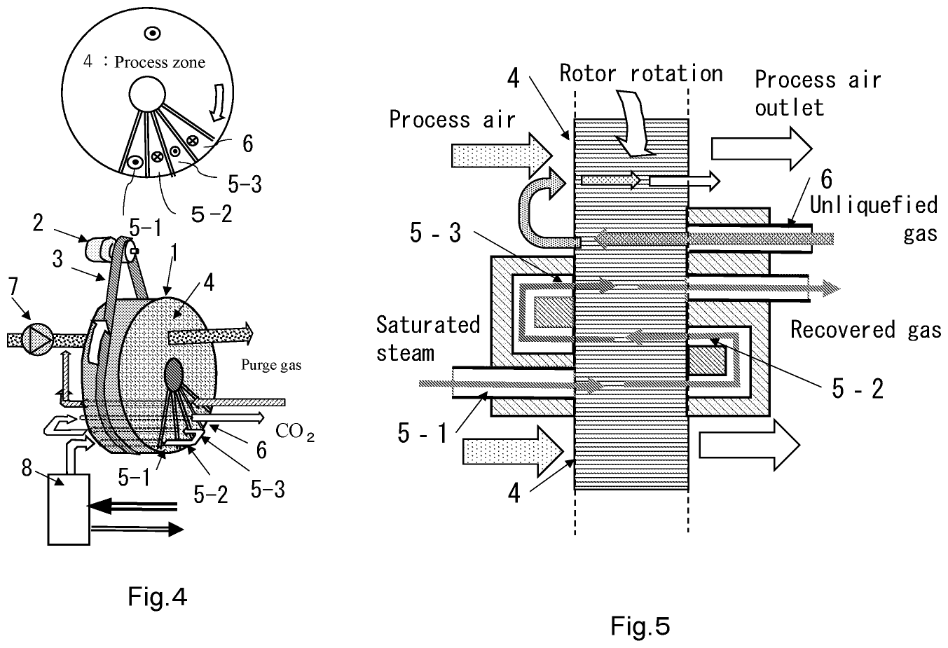

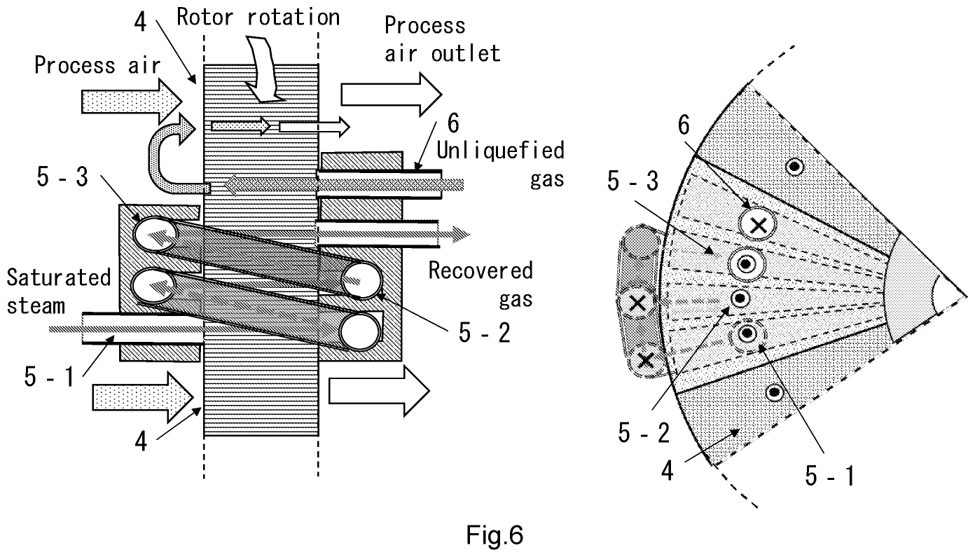

FIG. 3 shows the overall system diagram of Form 2. In the aforementioned wet TSA method, the system is ingeniously configured to further prevent thermal oxidative degradation of the sorbent, improve the recovery rate and concentration, and enhance energy efficiency. The details of the carbon dioxide gas separation and concentration system are explained in FIG. 4. Rotor 1, which can sorb carbon dioxide gas, is divided into a processing zone 4, a purge zone 6, a recovery zone second stage 5-3, a recovery zone first stage 5-2, and a desorption zone 5-1 in order of rotation direction, and is driven by a rotor drive motor 2 with a belt 3 The rotor is driven and rotated by the rotor drive motor 2 and the belt 3.

When air is introduced into the processing zone 4 of the rotor by the fan 7, the rotor in its moist state is simultaneously sorbing carbon dioxide gas and vaporizing and cooling the moisture, and the generated sorption heat is also cooled and removed. In the gas purge zone 6, which has moved in rotation, unliquefied gas from the liquefied carbon dioxide purification tank 16 is introduced to purge the air contained in the rotor void, and saturated vapor is introduced into the desorption zone 5-1 to sorb carbon dioxide gas sorbed on the rotor, and the first stage of the recovery zone 5-2 and further recovered through recovery zone 5-3 on the front side of the rotation. Reference numeral 17 is dry ice production equipment.

The gas flow in the rotor is described in more detail in FIG. 5. As the rotor rotates from the processing zone 4 to the purge zone 6, unliquefied gas is introduced, and the air in the rotor void is purged and exhausted toward the entrance of the processing zone 4, where it is mixed with the processing air and reintroduced into the processing zone. This purging has the effect of preventing air from mixing with the recovered gas, thereby increasing the concentration of recovered gas; avoiding thermal oxidative degradation of the sorbent in the high-temperature desorption zone 5-1, thereby improving durability; and improving recovery by allowing sorbent to contact carbon dioxide gas with a higher concentration than air immediately before sorption. The sorbent is also recovered. At the same time, the purity of the liquefied gas is improved by removing the unliquefied gas from the gas purification tank 16.

In the desorption zone 5-1, saturated vapor is introduced, and carbon dioxide gas is desorbed by the latent heat of condensation, and condensate remains in the rotor. The mixture of desorbed carbon dioxide gas and water vapor passes through the first stage 5-2 of the recovery zone at the front stage in the direction of rotation, then turns around and passes through the second stage 5-3 of the recovery zone to be recovered. The enthalpy (sensible and latent heat) of the desorption outlet gas is thus recovered in the residual heat of the rotor before desorption, and conversely, the enthalpy of the recovered gas is reduced by its passage, reducing the load on the cooling dehumidifying coil 10-1 in the next process.

The number of recovery zone stages can be further increased to three or four in the front stage in the direction of rotation after testing and confirming the excess or deficiency of its effectiveness. Experiments to date have confirmed the effectiveness of one stage, and have identified the need for additional stages and the possibility of improving energy efficiency by doing so. Such complex flow channel configurations and adiabatic treatment are difficult to achieve with conventional technology, but can be realized with the “stacked purge and recovery block” structure (Ref. 9). A laminated structure of fan-shaped sheets with or without each zone space, where the sliding surface in contact with the rotor end face has a heat-resistant and abrasion-resistant sliding sheet, the lower layer is a foam rubber sheet layer, the lower layer is a foam rubber sheet layer or foam plate layer with a connecting passage between each sheet, and the bottom layer is an insulation plate without a zone space The block is made by laminated and bonded together, and can be easily and cost-effectively manufactured using a “laminated structure purge and recovery block” of highly insulated structure with a vapor introduction section, desorption gas recovery section, and purge gas inlet/outlet section on the periphery or bottom surface.

### Third Embodiment of Carbon Dioxide Gas Separation and Concentration Equipment

FIG. 5 shows an example of sequentially introducing the gas into the rotor while reversing the direction of gas passage in the order of the desorption zone, first stage of the recovery zone, and second stage of the recovery zone toward the front of the rotor rotation. The gas is bypassed from each zone to the outer circumference of the rotor and passed sequentially in a spiral toward the front in the direction of rotation. The bypass can be constructed by laminating and bonding a silicone foam rubber tube or multiple sheets of silicone foam rubber or the like with or without gas channels cut out for ease of processing, assembly adjustment, and thermal insulation. Although this method is thermodynamically preferable, the structure is somewhat more complex and should be determined by cost-effectiveness. For air conditioning in a limited closed space such as a space ship, it may be assumed that performance is more important than cost.

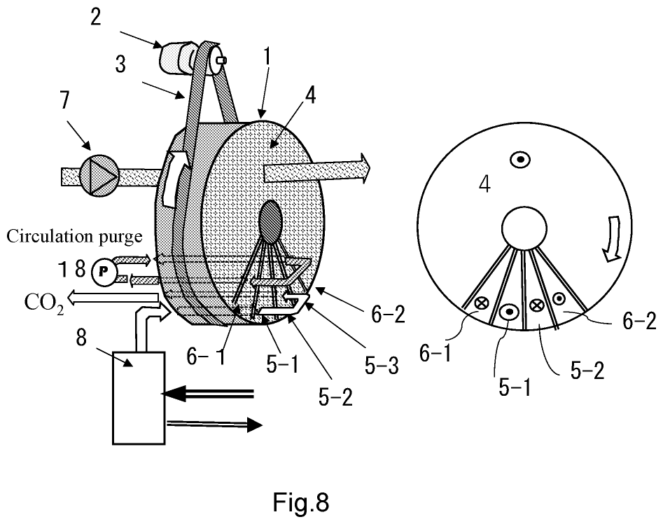

Let us estimate the amount of recovery and the scale of the wet TSA carbon dioxide separation and concentration system when it is actually put into practical use, based on the results of actual experiments (see Reference 9 in the patent document). FIG. 8 is a flow diagram of a small experimental apparatus actually implemented, which is similar to FIG. 4, but slightly different. For example, the purge gas is not the unliquefied gas, but the circulating purge zones 6-1 and 6-2, which are set up across the front and back of the recovery and desorption zones, from the desorption zone 5-1 to the desorption gas purge zone 6-1. The gas contained in the rotor void immediately after rotation is drained. It is then introduced into the treatment/process air purge zone 6-2 immediately after the process zone to purge the air contained in the rotor void, thereby preventing air contamination into the recovered gas. Reference numeral 8 is a treated air fan. Reference numeral 18 represents circulation purge pumps.

The rotor is an amine sorbent honeycomb with about 190 cells, and since the experimental data is in the process of optimization and adjustment, the concentration of recovered carbon dioxide gas is only about 50%, but it is possible to further increase the concentration by adjustment, and furthermore, by purging with unliquefied gas, a high concentration recovery of nearly 100% is expected.

The recovery rate of carbon dioxide gas from the outside air (the removal rate from the side of the passing air) is not high at about 45%, but the data is based on a rotor width of 50 mm and a flow velocity of 3.3 m/s of treated air. The rotor width affects the heat exchange efficiency for a total heat exchanger, the dehumidification volume for a dehumidifier, and the removal rate for a VOC concentration rotor, and when high performance is required, a rotor with a width of 200 to 600 mm or wider is selected. The pressure loss increases in direct proportion to the rotor width and flow velocity because it is a laminar flow area, and it also varies depending on the gas composition and temperature. For example, at an air velocity of 3.3 m/s and 30° C., the pressure loss is 550 Pa with 190 cells and 400 mm width, and 140 Pa with 50 mm width.

The 50 mm width is sufficient for the recovery rate for the present device for separation and concentration of carbon dioxide gas in the air. This is because, rather than aiming for a higher recovery rate, a simple and inexpensive axial flow fan such as a large ventilation fan can take in a large amount of process air and sorb a large amount of carbon dioxide gas with less power than a centrifugal fan, due to the advantages of a narrow rotor and low pressure loss. On the other hand, there is concern that the narrow width of the fan may reduce the sorption efficiency, but the proposed system collects the desorption exit gas by passing it through one or more collection zones at the front of the rotational direction, thereby improving energy conservation through sufficient desorption effect, preheating the rotor before sorption by enthalpy recovery effect, and the effect of pre-cooling and dehumidification of the sorption gas. The energy saving effect is also achieved by preheating the rotor before desorption and by pre-cooling and dehumidifying the desorption gas.

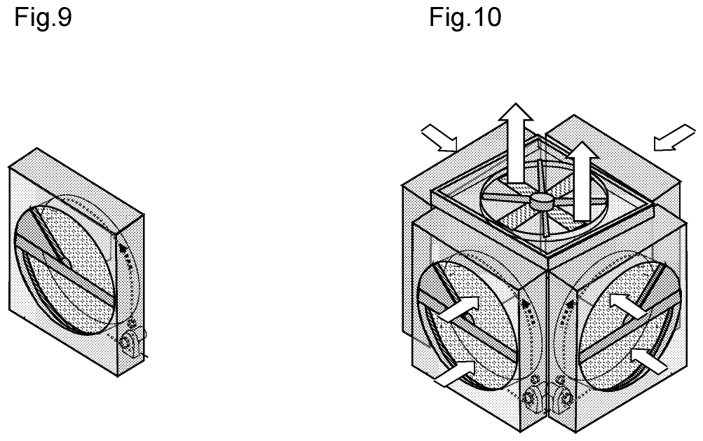

The scale of the actual machine is assumed based on experimental data. In the medium-sized cassette shown in FIG. 9 with a rotor diameter of approximately ϕ2000 mm and a rotor width of 50 mm, the treatment airflow rate is 4,000 m3/h. If the CO2 concentration is 400 ppm and the recovery rate is 45%, the amount of CO2 gas recovered is 8 m3/h≈14.2 kg/h/unit. If four units of this rotary set are combined in a square as shown in FIG. 10, only one large treatment fan is required, and it is possible to separate and concentrate 56 kg/h of carbon dioxide in the air with an installation area of about 2 tsubo.

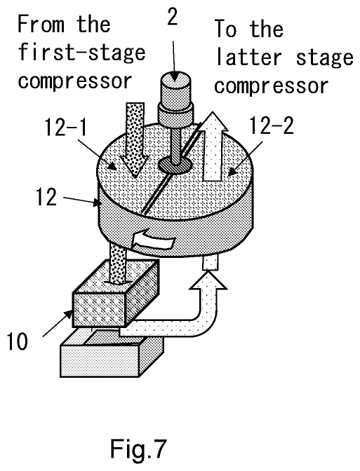

Back to the explanation of the system shown in FIG. 3. The recovered gas passes through the (gas) cooling coil 10-1, is cooled and dehumidified, and then introduced into the next stage of compression equipment 11-1, where it is heated by compressing. The heated gas is then introduced into the desorption zone 12-1 of the honeycomb rotor rotary adsorption dehumidifier 12 (detailed diagram is shown in FIG. 7), where the moisture adsorbed on the rotor is desorbed, and the heat of desorption causes the gas temperature to decrease and the absolute humidity to increase. Next, the gas is cooled and dehumidified simultaneously in the cooling/dehumidifying coil 10-2, introduced into the processing zone 12-2 for adsorption/dehumidification, and then introduced into the compression unit 11-2 for further compression. The combination of cooling/dehumidifying coil 10-2 and rotor type dehumidifier 12 allows dehumidification to a dew point temperature lower than the cooling water temperature, eliminating the need for the adsorption type two tower dehumidifier 13 shown in FIG. 1 of Form 1 and saving energy. Reference numeral 10-3 is another gas cooling coil.

Since it is difficult to liquefy carbon dioxide gas in one-stage compression, the gas leaving the process zone 12-2 of the rotor dehumidifier 12 is introduced into the second-stage compressor 11-2 and pressurized to about 4 Mpa. Although not shown in FIG. 3, if necessary, the gas is further recooled and pressurized to about 6.4 Mpa in the third-stage compressor. The pressurized gas is recooled and liquefied in the carbon dioxide liquefaction unit 15.

The liquefaction temperature must be cooled to below −15° C. at 2.2 Mpa, below 5° C. at 3.9 Mpa, and below 25° C. at 6.4 Mpa. High compression facilitates liquefaction, but requires more energy for the compressor. On the other hand, at lower pressures, liquefaction requires cooling to lower temperatures, but the dissolution of impure gases is reduced and the purity of liquefied carbon dioxide is improved. On the other hand, the load on the refrigerator increases and the coefficient of performance of the refrigerator deteriorates, so the energy requirement increases. According to Patent Document 7, JP-A-2006-193377, when producing dry ice, it is desirable to cool the ice to a supercooled state from the standpoint of dry ice production yield. The design should take various factors into consideration.

Since saturated vapor for desorption of carbon dioxide gas separation and concentration equipment is generated by a steam-generating heat pump by recovering and utilizing waste heat generated in the system such as the aforementioned cooling system and liquefaction refrigeration system, the increase in compression load and cooling load for dry ice production leads to an increase in waste heat source for saturated vapor generation, and the entire system can be supplemented The overall system is complementary and energy saving is improved. If there is a shortage of waste heat source, it can be supplemented with waste heat from cooling during the dry ice demand period, and solar heat is also abundant.

The outlet gas from the process has a low carbon dioxide concentration and can be used as air conditioning supply air. The air that passes through the process zone of the carbon dioxide gas separation and concentration rotor is cooled and dehumidified by the cooling coil and supplied to air conditioning, and the cooling coil drain water is collected and supplied to the saturated steam generator, enabling energy saving in air conditioning, added value to the system, and water saving. This method is an advantage that can be used for air conditioning in closed spaces such as space facilities.

Liquefied gas is put into a purification tank, but it contains unliquefied gas, and the unliquefied gas is usually exhausted to improve the purity of the liquefied gas. Unliquefied gas contains impure gas, but its main component is carbon dioxide gas. By introducing this unliquefied gas into the purge zone of the rotor type separation and concentration equipment, various problems caused by air contained in the rotor void due to rotor rotation migrating into the desorption zone can be eliminated. First, the purging of air has the effect of increasing the concentration of recovered carbon dioxide, and second, the passage of highly concentrated carbon dioxide gas through the recovery zone further increases gas sorption to the rotor and improves the amount of carbon dioxide gas recovery. Third, by not allowing oxygen-containing gases into the desorption zone, there is also the effect of preventing thermal oxidative degradation of the amine-based carbon dioxide sorbent in the desorption zone.

Liquefied carbon dioxide products need to be dehumidified so that the moisture content is within specifications, but in block dry ice production, carbon dioxide gas for dry ice applications does not need to be highly dehumidified like liquefied gas because it contains water and other solidifying agents to solidify the snow dry ice.

Although the system was designed as a dry ice production system in consideration of its widespread applicability as a precursor to CCU technology, it is also possible to further refine liquefied carbon dioxide into a liquefied carbon dioxide product without dry ice. In addition, the density of liquefied carbon dioxide is about 0.77 g/Cm3, while dry ice has a specific gravity of about 1.56 g/Cm3, which means that dry ice has half the volume and does not require heavy high-pressure cylinders. Industrial Potential] Industrial Potential

This proposed system relates to a dry ice production system using air conditioned carbon dioxide as the gas source, which is not limited to carbon dioxide emission sources or waste heat sources as in the past, and can produce the required amount of dry ice in the required region, when required, without stockpiling for seasonal fluctuations. The system is a complete system from carbon dioxide gas separation and concentration to product manufacturing, so it can be installed in dry ice demand areas on the scale of a small factory and can be air conditioned and supplied with air without increasing carbon dioxide gas emissions due to transportation. The system can be installed in a factory scale at a location where dry ice is in demand, and can be supplied with air-conditioned air.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A Dry ice production system having a steam-generating heat pump equipment that recovers waste heat from equipment that compresses, cools, and liquefies carbon dioxide gas in the system to generate steam, carbon dioxide gas separation and concentration equipment that separates and concentrates carbon dioxide gas from air and introduces said vapor to desorb and recover it with the heat of condensation of saturated vapor, equipment for cooling and dehumidifying saturated vapor and carbon dioxide gas mixtures collected in the separation and concentration unit, one or more compression units that compress cooled and dehumidified carbon dioxide gas to liquefy it, adsorption type dehumidifier to dehumidify compressed carbon dioxide gas, gas liquefiers and chillers that cool dehumidified carbon dioxide gas to liquefaction temperature, liquefied carbon dioxide purification tanks that introduce liquefied carbon dioxide gas, store liquefied carbon dioxide, and vent unliquefied gas, and dry ice production equipment that feeds liquefied carbon dioxide from a liquefied carbon dioxide refining tank and releases it under atmospheric pressure to produce dry ice by cooling and condensing carbon dioxide gas with the latent heat of its vaporization, where un condensed gas from dry ice production is returned to the compression system and collected, the carbon dioxide gas separator/concentrator has a rotor capable of sorbing carbon dioxide gas, said rotor is rotatably housed in a casing, said casing having a treatment zone, a purge zone and a desorption zone, each zone being sealed at least in the order of rotation direction. In the purge zone, unliquefied gas drained from the liquefied carbon dioxide purification tank is introduced to purge and exhaust the air contained in the rotor void, and in the desorption zone, saturated steam of around 100° C. generated by a steam-generating heat pump unit is introduced and condensation heat of the steam is used to adsorb the carbon dioxide gas, and the system is wet type TSA carbon dioxide gas separation and concentration system that uses carbon dioxide in the air as the gas source and can also be supplied with air conditioning.

2. The wet TSA carbon dioxide gas separation and concentration apparatus has a rotor capable of sorbing carbon dioxide gas in a casing that rotates, said casing having a treatment zone, a purge zone, one or more recovery zones, and a desorption zone, each zone being sealed to each other in the order of the direction of rotation of the rotor. In the purge zone, unliquefied gas from the liquefied carbon dioxide purification tank is introduced to exhaust the air contained in the rotor void, and in the desorption zone, saturated vapor at around 100° C. is introduced to desorb highly concentrated carbon dioxide gas by the condensation heat of the vapor, and a dry ice production system using carbon dioxide in air as a gas source that can also be supplied with air conditioning, as claimed in claim 1, wherein the recovery zone is a we TSA carbon dioxide gas separation and concentration system that collects said desorbed gas by sequentially passing it through one or more recovery zones toward the front stage in the direction of rotation.

3. Dry ice production using airborne carbon dioxide as a gas source that can also be used as an air conditioning supply, as claimed in claim 1, where the air that passes through the processing zone of the wet TSA carbon dioxide gas separation and concentration unit is cooled and dehumidified by a cooling coil and used as an air conditioning supply, and the drain water from the cooling coil is collected and used as a water supply for a saturated steam generator system.

4. A dry ice production system having a dehumidification portion in which a honeycomb rotor dehumidifier having a treatment zone and a regeneration zone is dehumidified by introducing compressed hot gas from a gas compressor into the regeneration zone of the honeycomb rotor dehumidifier to desorb adsorbed water from the rotor, passing the outlet gas through a cooling coil to cool and dehumidify it, and introducing it into the treatment zone for adsorption and dehumidification as a gas source that can also be using carbon dioxide in air as a gas source supplied by air conditioning as described in claim 1.
